(19) United States
(12) Patent Application Publication
(10) Pub. No.: US 2002/0088700 A1
(43) Pub. Date: Jul. 11, 2002

(54) Slide actuated switch

(76) Inventors: Mark Jonathan Banfield, Colehill (GB); Barry Voss, Waterlooville (GB)

Correspondence Address: LOWE HAUPTMAN GOPSTEIN, GILMAN AND BERNER LLP, SUITE 310, 1700 DIAGONAL ROAD, ALEXANDRIA, VA, 22314

(21) Appl. No.: 10/042,392

(22) Filed: Jan. 11, 2002

(30) Foreign Application Priority Data
Jan. 11, 2001 (GB) 0100772.3

(51) Int. Cl. H01H 3/42

(52) U.S. Cl. 200/573

(57) ABSTRACT

The switch includes a microswitch switching mechanism having a biassed plunger. The body of the switching mechanism is covered by a lid having a user-operated slider mounted thereon. Movement of the slider is confined to a track formed in the lid. A cam surface is provided on a part of the slider which is engageable with the plunger of the switching mechanism. The “over-centre” profile of the cam surface is such that movement of the slider in one direction causes the plunger to be depressed and then released. Inadvertent operation of the switch is avoided due to the cam profile.

### TECHNICAL FIELD

This invention relates to electrical switches and more particularly, though not solely, to slide actuated switches.

### BACKGROUND OF THE INVENTION

Slide actuated switches come in a variety of forms. A common type has a strip of conductor material mounted on a slider and fixed contacts connected to terminals of the switch mounted in a body. Movement of the slider relative to the body moves the strip of conductor material into and out of contact with the fixed contacts to provide a switching action. Such a switch has only a slow make and break and is therefore only suitable for low voltage and low current applications. Another type of slide actuated switch relies upon the slider movement causing a pivoting movement of a conductor member from one to the other of two extreme positions. In the extreme positions the conductor member makes different connections with fixed contacts. Such a switch has a “snap-over” action and so speeds up the make and break connection but it is still only useful with relatively low currents.

Another very common type of switch which is in widespread use is a so-called “microswitch”. Such switches normally have at least three terminals which provide a normally OFF function and a normally ON function. Such switches can include more terminals and may have a changeover function. Typically such microswitches include an actuating plunger and it is movement of the plunger into and out of the body of the microswitch which actuates the switching function. Such microswitches are quite often incorporated into push-button type switches but they can include a lever pivotally mounted on the body which engages and operates the plunger. The free end of such a lever may include a roller so that it can operate with a profiled rotary cam. Such microswitches are a commodity item and accordingly inexpensive and they can handle relatively high currents and voltages, typically 250 volts at 10 amps.

### SUMMARY OF THE INVENTION

According to this invention a slider actuated switch comprises a microswitch switching mechanism including a biassed plunger mounted in a body, a slider mounted on and co-operating with the body so that it is capable of sliding backwards and forwards along the body, and a cam associated with the slider and engaging the biassed plunger as the slider is moved backwards and forwards to operate the plunger and thereby actuate the microswitch switching mechanism.

Preferably the microswitch switching mechanism is entirely conventional in construction and preferably it is of a type that includes a body formed in two parts, a first part which contains and forms part of the switching mechanism and a second part or lid. In this case the lid is modified to provide a track which constrains and cooperates with the slider to control its movement in the backwards and forwards direction.

Preferably the cam is profiled to provide an “overcentre” action. Thus, with the slider at one extreme position of its travel the slider is either out of contact with the plunger or at least only just touching the plunger. As the slider is moved towards the other extreme of its travel the cam is profiled to engage the plunger and depress it to its fully depressed position as the slider is in the centre of its travel and then to release the plunger slightly when the slider reaches the other extreme end of its travel. In this way, the bias of the plunger has to be overcome when any attempt is made to return the slider to its starting point and consequently this prevents the slider moving under vibration alone, for example.

Typically sliding switches in accordance with this invention are stacked next door to one another to provide a gang of slider switches and, in this case, each microswitch preferably includes two tangs so that each slider switch engages the walls of a surrounding mounting frame or case holding the gang of slider switch assemblies in position side-by-side. When the switch is to be used in this fashion one side of the track formed by the lid can be entirely open to facilitate the assembly of the slider with the track and then, once a number of switches are arranged side-by-side the sliders in each switch are prevented from being removed from the track either by the neighbouring slider actuated switch or by the side wall of the mounting frame or case in which all of the slider switches are mounted.

### BRIEF DESCRIPTION OF THE DRAWINGS

A particular example of the slider actuated switch in accordance with this invention will now be described with reference to the accompanying drawings, in which:

FIG. 1 is a perspective view of the complete switch;

FIG. 2 is a side elevation of a switch in the “OFF” position;

FIG. 3 is a side elevation of the switch in an intermediate position;

FIG. 4 is a side elevation of the switch in the “ON” position; and,

FIG. 5 is a perspective view of ganged arrangements of switches in accordance with this invention.

### DETAILED DESCRIPTION OF THE PREFERRED EMBODIMENT

The slider actuated switch comprises a standard microswitch 1 such as an ITW type 16 microswitch made and sold by ITW Switches of Norway Road, Hilsea, Portsmouth, Hampshire, PO3 8HT, United Kingdom, a frame 2 and a slider 3. The frame 2 forms and replaces the lid of the otherwise conventional microswitch 1 and includes a rear face, side faces 4 and 5 and an interrupted top face 6 including an aperture 7. The slider 3 includes an actuator 8 for engagement by the user and a foot 9 including a profiled cam surface 10. The foot 9 extends through the aperture 7 in the top wall 6 of the frame 2 and slots formed between the actuator 8 and the foot 9 embrace the interrupted top wall 6 to locate the slider 3 in position and control its movement backwards and forwards along the top of the frame 2. The profiled cam surface 10 engages a spring-loaded plunger 11 of the microswitch 1.

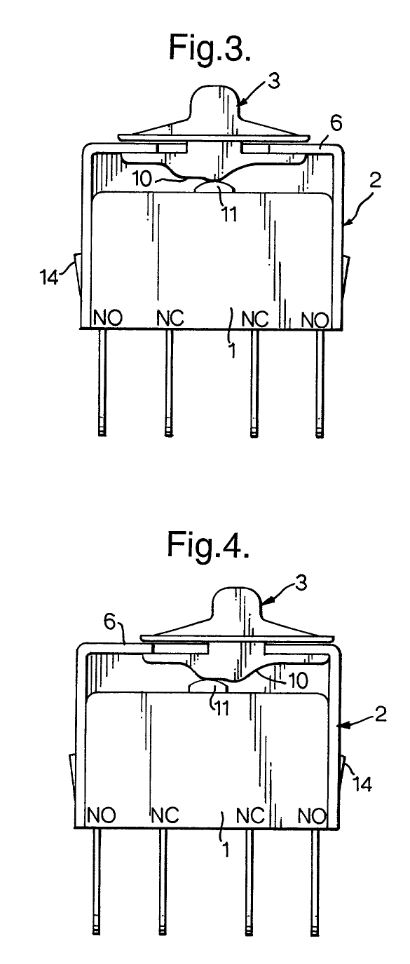

In this example the microswitch 1 is of the type which has two contacts connected to terminals marked NO in FIGS. 2 to 4 which are normally open and two contacts connected to terminals marked NC which are normally closed. In the normal or unactuated position as shown in FIG. 2 the slider 3 is located at the extreme leftmost position and in this position the plunger 11 of the microswitch 1 is in its outermost position. As the slider 3 is moved towards the right, as shown in FIG. 2, the profiled cam surface 10 causes the plunger 11 to be depressed into an extreme depressed position as shown in FIG. 3 before allowing it to release slightly into the position shown in FIG. 4 when the slider 3 reaches its extreme rightmost position. This is the actuated position of the microswitch and thus, in this position a connection is established between the NO terminals and there is no connection between the NC terminals. The “over-centre” profile of the cam surface 10 ensures that the slider 3 does not return inadvertently to its unactuated position, for example, as a result of vibration. However it can of course be returned manually to change the state of the microswitch 1.

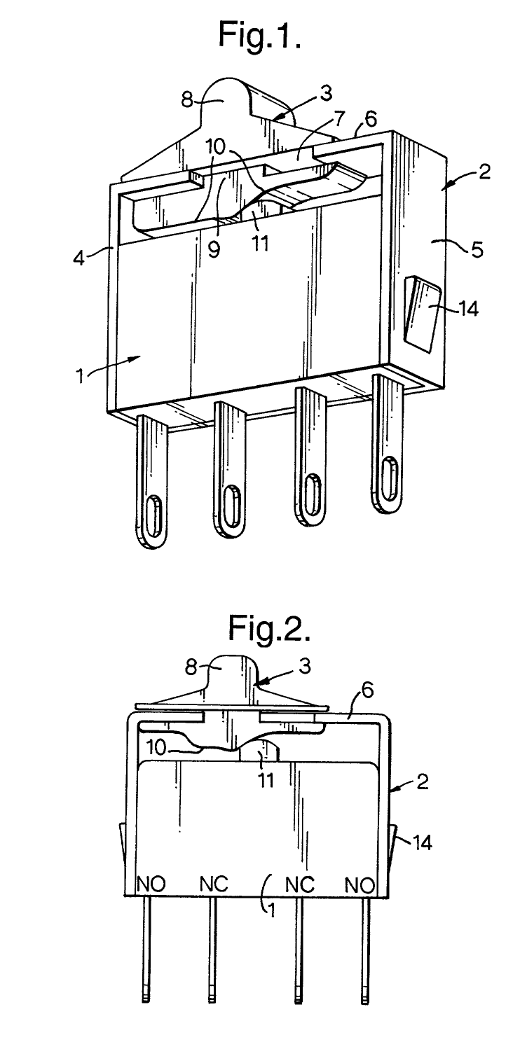

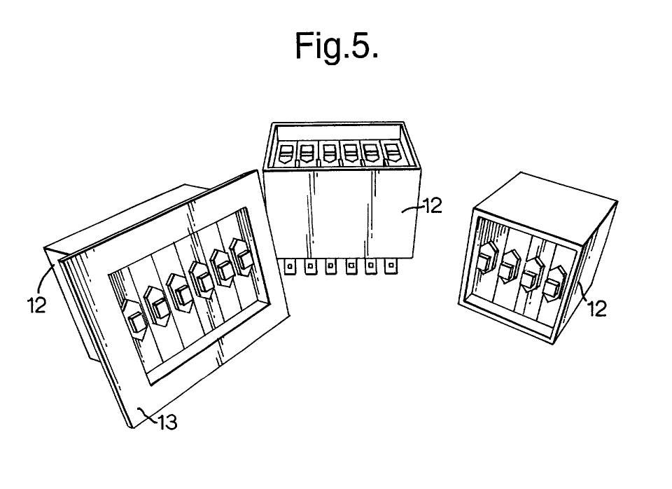

FIG. 5 illustrates three examples of gangs of slider switch assemblies. On the left is shown a six pole panel mounting slide switch assembly, in the centre is a six pole PCB mounting slider switch assembly and on the right is a four pole PCB mounting slide switch assembly. In each of these switch assemblies, switches as shown in the previous drawings are inserted side-by-side in a casing 12 which, for the panel mounting arrangement includes a flange 13. The switches are held in the frame 12 by the projections 14 shown most clearly in FIGS. 1 to 4.

We claim:

1. A slider actuated switch comprising:
a microswitch switching mechanism including a biassed plunger mounted in a body,
a slider mounted on and co-operating with the body so that it is capable of sliding backwards and forwards along the body, and
a cam associated with the slider and engaging the biassed plunger as the slider is moved backwards and forwards to operate the plunger and thereby actuate the microswitch switching mechanism.

2. A slider actuated switch as claimed in claim 1, wherein the microswitch switching mechanism is entirely conventional in construction and wherein it is of a type that includes a body formed in two parts, a first part which contains and forms part of the switching mechanism and a second part or lid.

3. A slider actuated switch as claimed in claim 2, wherein the lid is modified to provide a track which constrains and co-operates with the slider to control its movement in the backwards and forwards direction.

4. A slider actuated switch as claimed in any one of the preceding claims, wherein the cam is profiled to provide an “over-centre” action.

5. A slider actuated switch as claimed in claim 4, wherein at one extreme position of its travel, the slider is either out of contact with the plunger or at least only just touching the plunger, and as the slider is moved towards the other extreme of its travel the cam is profiled to engage the plunger and depress it to its fully depressed position as the slider is in the centre of its travel and then to release the plunger slightly when the slider reaches the other extreme end of its travel.

6. A gang of slider switches comprising a plurality of slider actuated switches according to any one of claims 1 to 3, stacked next to one another wherein each microswitch includes two tangs so that each slider actuated switch engages the walls of a surrounding mounting frame or case holding the plurality of slider actuated switch assemblies in position side-by-side.

7. A gang of slider switches as claimed in claim 6, wherein one side of the track formed by the lid is entirely open to facilitate the assembly of the slider with the track and then, once a number of switches are arranged side-by-side the sliders in each switch are prevented from being removed from the track either by the neighbouring slider actuated switch or by the side wall of the mounting frame or case in which all of the slider actuated switches are mounted.
